(19) United States
(12) Patent Application Publication
(10) Pub. No.: US 2008/0001933 A1
(43) Pub. Date: Jan. 3, 2008

(54) Digital photo frame that auto-adjusts a picture to match a display panel

(75) Inventors: Tain-Rein Chen, Hsinchu (TW); Chao-Kai Sung, Hsinchu (TW)

Correspondence Address: KAMRATH & ASSOCIATES P.A., 4825 OLSON MEMORIAL HIGHWAY, SUITE 245, GOLDEN VALLEY, MN, 55422, US

(73) Assignee: AVID ELECTRONICS CORP., Hsinchu (TW)

(21) Appl. No.: 11/478,030

(22) Filed: Jun. 29, 2006

(51) Int. Cl. G09G 5/00

(52) U.S. Cl. 345/204

(57) ABSTRACT

A digital photo frame having auto-adjusting capability to match a picture and a display panel includes a frame body, an input and output interface, a control unit, an image processing unit, and a display panel and a control panel. The control unit determines whether a picture matches with the display panel according to a digital image format of the picture. If the picture matches with the display panel, the picture is direct displayed on the display panel. If the picture mismatches with the display panel, the control unit rotates the picture and then to display the picture on the display panel. Therefore, the picture can be auto-adjusted to match with the display panel.

### BACKGROUND OF THE INVENTION

1. Field of the Invention

The invention relates in general to a digital photo frame, and more particularly to a digital photo frame that auto-adjusts a picture to match a display panel of the photo frame.

2. Description of the Related Art

Digital products are more and more popular nowadays. Many conventional devices are replaced by digitalized devices: a digital camera is a good example. However, while the digital camera becomes available to the consumers, the conventional way to develop photos and to display the photos on conventional photo frames is out of time. In addition, the conventional way to develop photos costs time and money to keep the photos.

In view of the above disadvantage to keep photos, a digital photo frame is brought to the market. The digital photo frame includes devices such as a display panel (liquid crystal display; LCD) and a card reader. Users only need to insert a memory card of the digital camera to the card reader of the digital photo frame to display digital pictures on the LCD of the digital photo frame. The digital pictures can be selected to display on the digital photo frame or can be circularly displayed. Hence the cost and the inconvenience to develop the photos can be saved. Therefore the digital photo frame is widely acceptable by the consumers.

General photos can be classified into two types: a horizontal type when the photo width is larger than the photo height, and a vertical type when the photo width is smaller than the photo height. The digital photo frame can determine the type of the photo according to the properties of the photo formed in a digital format. Since the horizontal type photos are common, the digital photo frame is often manufactured in the same type. However, when the digital photo frame displays the vertical type photo, both regions of the photo show black and also the whole photo size becomes too small in order to fit the display panel of the digital photo frame. Hence the digital photo frame still can be further improved.

### SUMMARY OF THE INVENTION

The present invention provides a digital photo frame that auto-adjusts a picture to match a display panel.

In order to achieve the above objective, a main technique of the present invention includes a frame body, an input and output interface, a control unit, an image processing unit, and a display panel and a control panel. The control unit determines whether a picture matches with the display panel according to a digital image format of the picture. If the picture matches with the display panel, the picture is direct displayed on the display panel. If the picture mismatch with the display panel, the control unit rotates the picture and then to display the picture on the display panel. Therefore, the picture can be auto-adjusted to match with the display panel.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first preferred embodiment of the present invention.

FIG. 2 is a block diagram of the first preferred embodiment of the present invention.

FIG. 3 is a work flow diagram of the first preferred embodiment of the present invention.

FIG. 4A and FIG. 4B illustrate a motion of a display panel of the first preferred embodiment of the present invention.

FIG. 5 is a block diagram of a second preferred embodiment of the present invention.

### DETAILED DESCRIPTION OF THE INVENTION

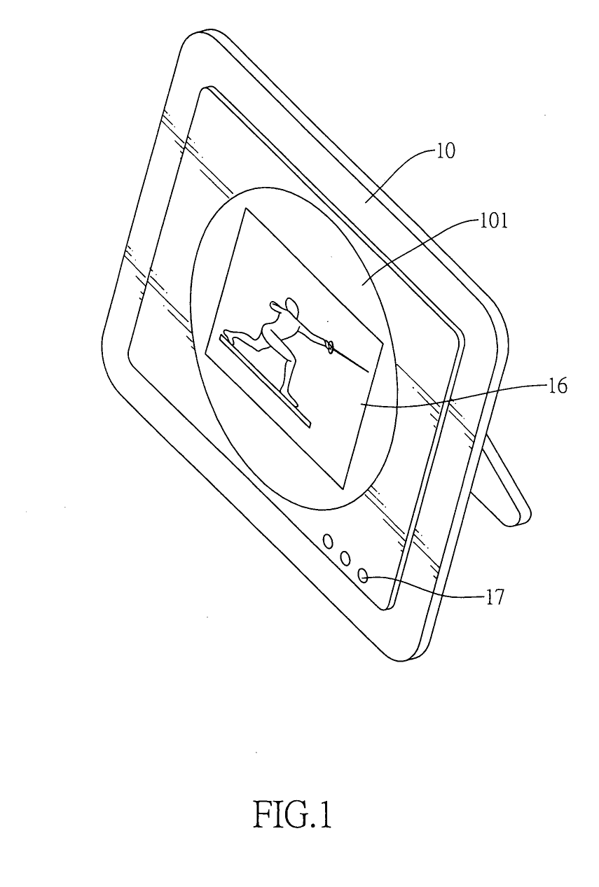

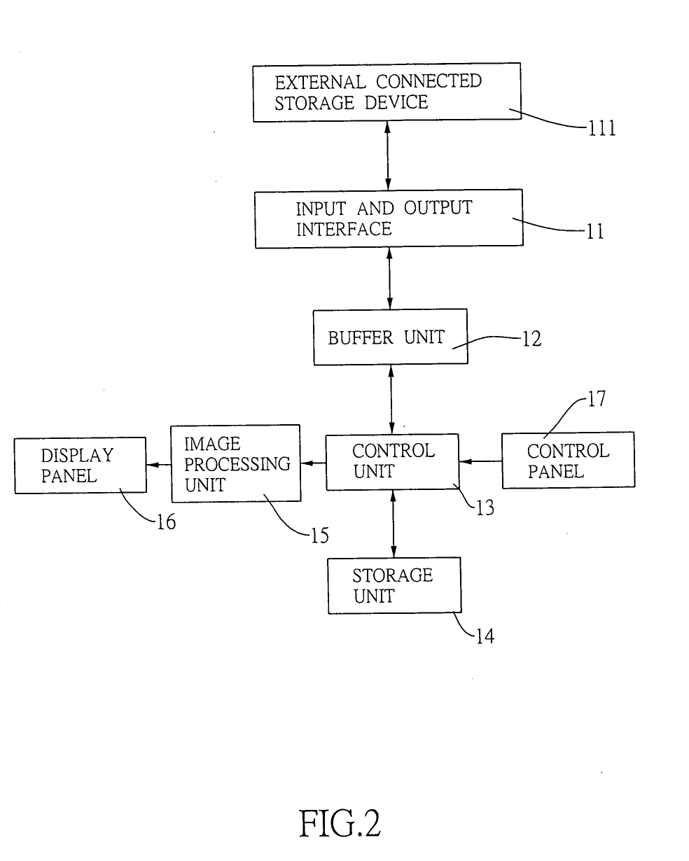

With reference to FIGS. 1 and 2, a first preferred embodiment of the present invention includes a frame body (10), an input and output interface (11), a buffer unit (12), a control unit (13), a storage unit (14), an image processing unit (15), a display panel (16) and a control panel (17).

The frame body (10) is rectangular and has a front side and a rotatable circular frame (101) configured on the front side of the frame body (10).

The input and output interface (11) is configured inside the frame body (10) and is used to connect to an external storage device (111) to read multiple pictures formed as a digital image formats stored in the external storage device (111).

The buffer unit (12) is connected to the input and output interface (11) to temporary store the pictures read from the external storage device (111).

The control unit (13) is configured inside the frame body (10) connected to the buffer unit (12). The control unit (13) is a processing center of the digital photo frame in accordance with the present invention. The control unit (13) determines whether the pictures stored in the buffer unit (12) are of horizontal or vertical types according to the properties of the digital image formats. If the picture is the vertical type, the picture will be rotated to be as a horizontal type.

The storage unit (14) is configured inside the frame body (10) for storing pictures.

The image processing unit (15) is configured inside the frame body (10) coupled to the control unit (13) for processing the pictures.

The display panel (16) is configured on the rotatable circular frame (101) and coupled to the image processing unit (15). The display panel (16) forms a standard rectangle having a large width and a short length. The display panel (16) is used to display the pictures.

The control panel (17) is configured on the front side of the frame body (10) and coupled to the control unit (13). Users select a specific picture to display on the display panel (16) by using the control panel (17).

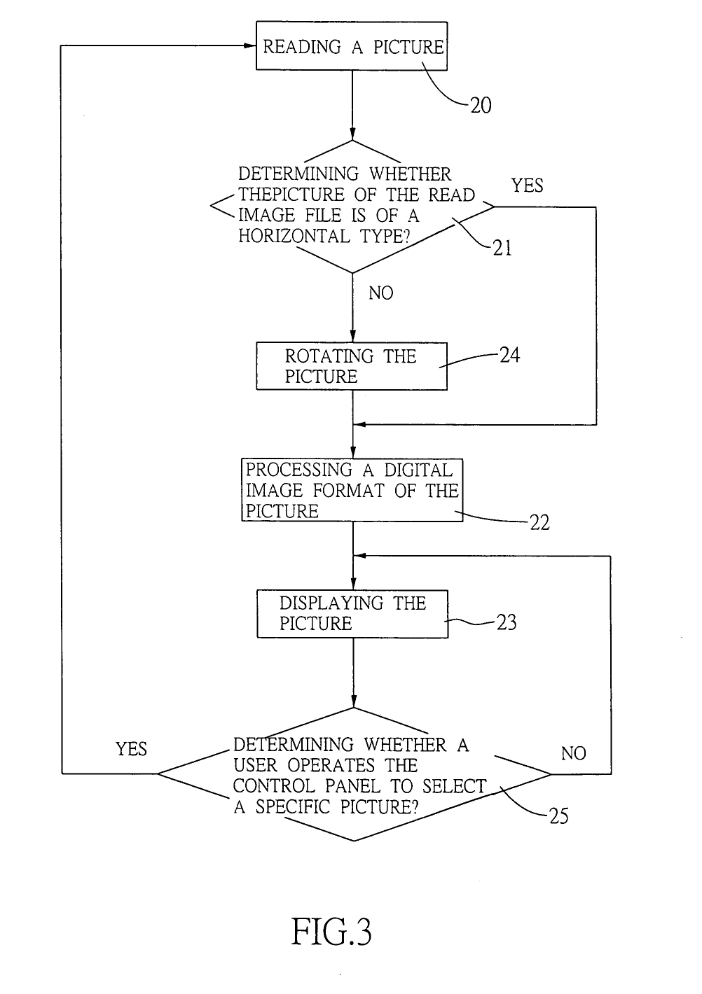

With reference to FIG. 3, a flow chart of the first preferred embodiment of the present invention includes steps as follows.

In a step (20), the external storage device (111) or the storage unit (14) reads a picture. The control unit (13) determines whether the picture formed in the digital image format is of a horizontal type in a step (21). If the present picture is the horizontal type, the present picture is processed by the image processing unit (15) in a step (22). And then the display panel (16) displays the picture in a step (23). On the other hand, if the picture is the vertical type, the control unit (13) rotates the picture in a step (24). And then the picture is processed by the image processing unit (15) in the step (22) to be displayed in the display panel (16) in the step (23). In this way, the original vertical picture can be transformed to the horizontal type to fill in the whole display panel (16). Hence an issue that the vertical picture is too small to fit the display panel (16) or black images on both sides of the display panel (16) can be solved.

After step (23), a step (25) is further added to determine whether a user operates the control panel (17) to select a specific picture to display. If the control panel (17) is used, then the process goes back to the initial step (20) to read another picture from the external storage device (111) or the storage unit (14). If the control panel (I 7) is not used by the user, then the picture is still displayed as in the step (23).

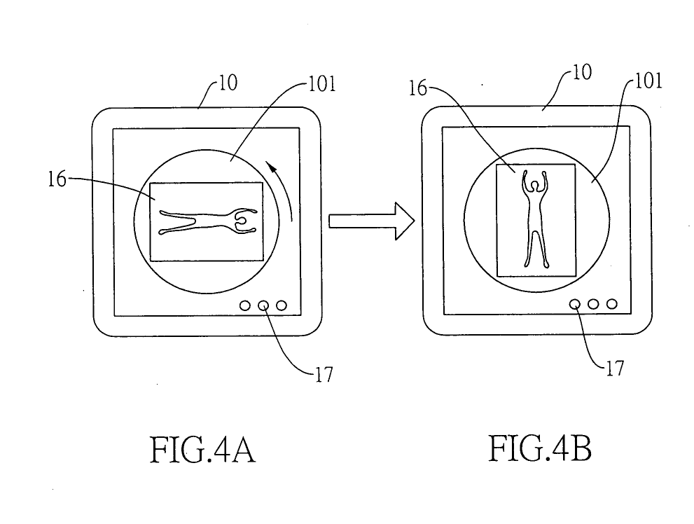

With reference to FIG. 4A, although the vertical type picture is rotated to fit the display panel (16) by the forgoing steps, the view angel of the picture is not correct. The user further rotates the rotatable circular frame (101) to adjust the angel of the display panel (16) to fit with the angel of the picture. Therefore, with reference to FIG. 4B, the digital photo frame (10) not only adjusts the picture to fills in the display panel (16) but also displays the correct angel of the picture. In addition, the first preferred embodiment makes use of the rotatable circular frame (101) to rotate the picture. However, in the practical application, even though the digital photo frame does not include the rotatable circular frame (101), the same objective still can be achieved by rotating the frame body (10) to ninety degrees, which should still belong to the scope of the present invention.

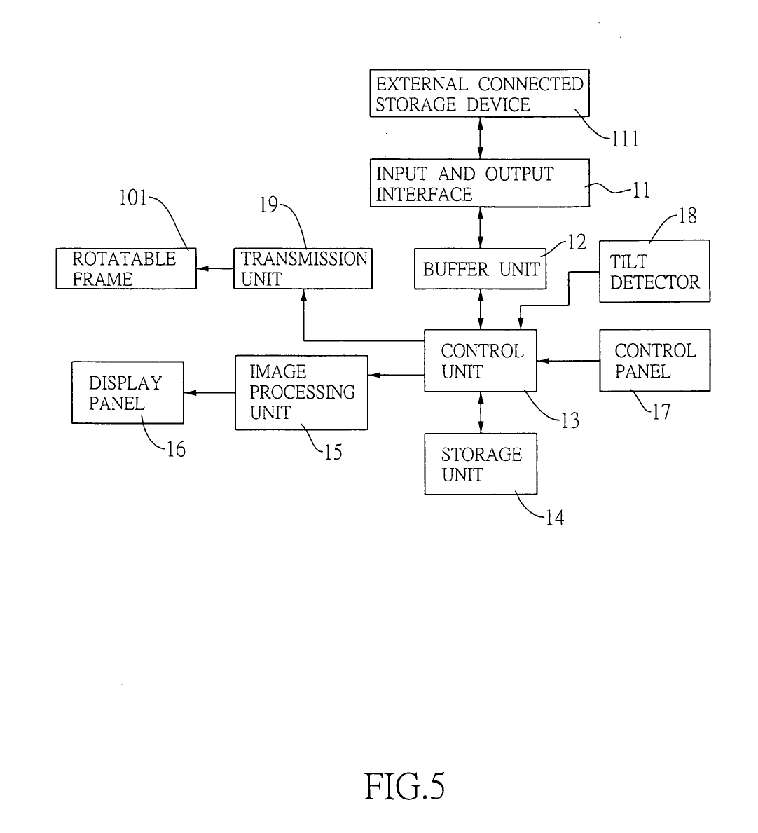

With reference to FIG. 5, a second preferred embodiment of the present invention is approximately similar to the first preferred embodiment of the present invention. The difference of the second preferred embodiment is that the digital photo frame further includes a tilt detector (18) and a transmission unit (19). Thereby the display panel (16) of the present invention can auto-rotate to get rid of inconvenience of manual-operation.

The tilt detector (18) is configured on the rotatable circular frame (101) with a level basis when the display panel (16) is of the horizontal type to detect whether a direction of the display panel (16) is of the horizontal or the vertical types.

The transmission unit (19) is coupled between the control unit (13) and the circular frame (101). The control unit (13) controls the transmission unit (19) to rotate the circular frame (101), so as to further rotates the display panel (16) to the correct direction of the pictures.

With the second preferred embodiment, the user does not need to manually operate the display panel to display picture in the correct direction. The digital photo frame of the present invention can auto-detect the picture format and auto-rotate the circular frame (101) to rotate the display panel (16) to show the picture in the correct direction.

Furthermore, a third preferred embodiment of the present invention is approximately similar to the second preferred embodiment. The difference of the third preferred embodiment is that the control unit (13) is further set a display order for the pictures stored in the storage unit (14) in accordance with the digital image format thereof. Therefore, the control unit (13) can continuously display the same type pictures. Hence the user or the transmission unit (19) can get rid of the inconvenience that the display panel (16) has to be repeatedly rotated to display the pictures correctly due to different picture formats.

It can be clearly understood from the above description that the digital photo frame that can auto-adjust the pictures to match the display panel of the present invention can detect whether the pictures are the horizontal or vertical types by using the control unit. If the detected picture is the horizontal type, the picture is directly displayed on the display panel. On the other hand, if the detected picture is of the vertical type, the control unit rotates the picture and then to display the picture on the display panel. In this way, the picture can be auto-adjusted to match the display panel, so as to avoid the conventional photo frame to display the vertical picture on the horizontal display panel and cause the black regions in the both sides of the picture or to reduce the picture size. Therefore the digital photo frame that can auto-adjust the pictures to match the display panel of the present invention indeed includes features of good utility and unobviousness to meet the requirements of a patent.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A digital photo frame having auto-adjusting capability to match a picture and a display panel comprising:
a frame body having a front side;
an input and output interface configured inside the frame body to read a plurality of pictures;
a control unit configured inside the frame body coupled to the input and output interface to determine a digital image format of each picture;
an image processing unit coupled to the control unit; and
a display panel configured on the front side of the frame body and coupled to the image processing unit;
whereby when the control unit determines that the digital image format of picture is mismatched with the display panel, the control unit rotates the picture to match with the display panel.

2. The digital photo frame as claimed in claim 1 further comprising a storage unit configured inside the frame body and coupled to the control unit to store the plurality of pictures.

3. The digital photo frame as claimed in claim 1 further comprising a control panel configured on the front side of the frame body and coupled to the control unit.

4. The digital photo frame as claimed in claim 1 further comprising a buffer unit coupled between the input and output interface and the control unit to store the plurality of the pictures read from the input and output interface.

5. The digital photo frame as claimed in claim 1 further comprising a rotatable frame configured on the front side of the frame body, wherein the display panel is configured on the rotatable frame.

6. The digital photo frame as claimed in claim 2 further comprising a rotatable frame configured on the front side of the frame body, wherein the display panel is configured on the rotatable frame.

7. The digital photo frame as claimed in claim 3 further comprising a rotatable frame configured on the front side of the frame body, wherein the display panel is configured on the rotatable frame.

8. The digital photo frame as claimed in claim 4 further comprising a rotatable frame configured on the front side of the frame body, wherein the display panel is configured on the rotatable frame.

9. The digital photo frame as claimed in claim 5 further comprising a transmission unit configured inside the frame body and coupled between the control unit and the rotatable frame, wherein the control unit controls the transmission unit to rotate the circular frame, so as to further rotates the display panel.

10. The digital photo frame that can auto-adjust a picture to match a display panel as claimed in claim 6 further comprising a transmission unit, wherein the transmission unit is configured inside the frame body coupled between the control unit and the circular frame, wherein the control unit controls the transmission unit to rotate the circular frame, so as to further rotate the display panel.

11. The digital photo frame that can auto-adjust a picture to match a display panel as claimed in claim 7 further comprising a transmission unit, wherein the transmission unit is configured inside the frame body coupled between the control unit and the circular frame, wherein the control unit controls the transmission unit to rotate the circular frame, so as to further rotate the display panel.

12. The digital photo frame that can auto-adjust a picture to match a display panel as claimed in claim 8 further comprising a transmission unit, wherein the transmission unit is configured inside the frame body coupled between the control unit and the circular frame, wherein the control unit controls the transmission unit to rotate the circular frame, so as to further rotate the display panel.

13. The digital photo frame as claimed in claim 9 further comprising a tilt detector configured on the rotatable frame and coupled to the control unit, wherein the tilt detector is used to detect a direction of the display panel and output a detecting result to the control unit.

14. The digital photo frame as claimed in claim 10 further comprising a tilt detector configured on the rotatable frame and coupled to the control unit, wherein the tilt detector is used to detect a direction of the display panel and output a detecting result to the control unit.

15. The digital photo frame as claimed in claim 11 further comprising a tilt detector configured on the rotatable frame and coupled to the control unit, wherein the tilt detector is used to detect a direction of the display panel and output a detecting result to the control unit.

16. The digital photo frame as claimed in claim 12 further comprising a tilt detector configured on the rotatable frame and coupled to the control unit, wherein the tilt detector is used to detect a direction of the display panel and output a detecting result to the control unit.

17. The digital photo frame as claimed in claim 2, wherein the control unit is built-in with a processing procedure, wherein the processing procedure is set a displaying order of the plurality of pictures according to the digital formats of the plurality of pictures stored in the storage unit.
